(19) United States
(12) Patent Application Publication
(10) Pub. No.: US 2010/0262751 A1
(43) Pub. Date: Oct. 14, 2010

(54) Memory Control Unit Mapping Physical Address to DRAM Address for a Non-Power-of-Two Number of Memory Ranks Using Lower Order Physical Address Bits

(75) Inventor: Karthikeyan Avudaiyappan, Sunnyvale, CA (US)

Correspondence Address: MARSH FISCHMANN & BREYFOGLE LLP;(Oracle formerly d/b/a Sun Microsystems), 8055 East Tufts Avenue, Suite 450, Denver, CO, 80237, US

(73) Assignee: SUN MICROSYSTEMS, INC., Santa Clara, CA (US)

(21) Appl. No.: 12/421,469

(22) Filed: Apr. 9, 2009

(51) Int. Cl. G06F 12/06; G06F 12/00

(52) U.S. Cl. 711/5; 711/105; 711/202; 711/E12.001; 711/E12.078

(57) ABSTRACT

A processor for low rank addressing of processor memory with non-power-of-two ranks. The processor includes cores that receive access requests to the processor memory (e.g., one or more DIMMs). The processor includes a memory controller connected to the core(s) that generates an address to the processor memory. The generating of the address includes identifying select rank bits in the physical address, determining whether the select rank bits map to a rank that is absent, and, when the physical address maps to an absent rank, modifying the physical address to include a modified set of select rank bits that are mapped to one of the ranks present in the processor memory. The modifying of the physical address may include swapping the lower rank bits with a higher order set of bits in the physical address. The memory controller proceeds with PA to DA conversions with the modified physical address.

### BACKGROUND OF THE INVENTION

1. Field of the Invention

The present invention relates, in general, to processor memory systems including low rank memory systems, and, more particularly, to a memory control unit (MCU) or memory controller, and processors including such a MCU, adapted with logic for supporting low rank addressing when the number of ranks in processor memory is either or a power of two or a non-power of two (such as 3, 5, or the like) to allow more flexibility in designing and expanding capacity of a processor memory system.

2. Relevant Background

In a typical computer, a memory controller or memory control unit (MCU) is provided as a separate chip on a motherboard or on the processor or central processor unit (CPU) die (i.e., the MCU is part of the processor or CPU chip). The MCU manages the flow of data going to and from the processor's memory system. The memory system may be made up of dynamic random access memory (DRAM) that software or applications access with read and write requests, for example, and the MCU contains the logic used to read and write DRAM and to refresh the DRAM. Briefly, the MCU controls access to the processor memory or DRAM by converting a physical address (PA) presented in read requests into a DRAM address (DA), with a PA being the memory address that is electronically (e.g., in the form of a binary number) presented on the computer address bus circuitry and seen by the software or application.

In some cases, the main memory or processor memory is provided in the form of dual in-line memory modules or DIMMs that are each made up of a series of DRAM integrated circuits. DIMMs are mounted on a printed circuit board that can be connected to the motherboard for access by the processor (or processors) to be managed by the MCU (or MCUs) of the computer (such as a personal computer, workstation, server, or the like). A standard DIMM may provide a 64-bit or 72-bit data path and provide up to 2 to 4 gigabytes (GB) or more of data storage capacity. The number of ranks on any DIMM is the number of independent sets of DRAMs that can be accessed for the full data bit-width of the DIMM (e.g., 64 or 72 bits), and DIMMs may be manufactured with up to four or more ranks. The ranks cannot be accessed simultaneously as they share the same data path. In one example, a single rank DIMM may have 72 data bits of input/output (I/O) pins, and one set of DRAMs are turned on to drive a read or receive a write on all 72 bits (with the MCU designed to access the full bus width of the memory module at the same time). In another example, on a 72-bit DIMM made with two ranks, there may be two sets of DRAM that could be accessed one at a time. Likewise, if there are more than two DIMMs with one or more ranks each, each rank and DIMM is accessed one at a time. A rank is accessed through a chip select (CS), which is typically the name of a control line in digital electronics used to select one chip or one set of chips, out of several connected to the same computer bus (e.g., using three-state logic). For example, for a two rank module, the two DRAMs with data bits tied together may be accessed by a CS per DRAM (e.g., CS0 goes to one set of DRAM chips and CS1 goes to the other).

In some processors or computer, the memory controller or MCU is adapted with logic to provide PA to DA conversion using a low rank scheme. In the low rank scheme, some of the lower order bits of the PA are used to select a rank in the processor memory system or main memory (e.g., for the rank portion of the DA address). For example, Sun Microsystems, Inc.'s SPARC processors (including the KT processor) have a MCU or memory system that uses the lower order bits of the PA to select a rank among a number of available ranks. The use of lower order address bits has been shown to distribute the read and write accesses uniformly across all the available ranks and to yield high performance. Low rank addressing, however, only works well if the number of ranks in processor memory or the memory system are equal to a power of two (i.e., equal to 2̂N, where N is a positive integer). Unfortunately, this often results in a computer with too little or too much memory capacity. For example, a customer or computer designer may want to upgrade or design a computer with 12 GB of memory capacity, but, since this is not a power of two, the computer may have to be designed to have 8 GB or 16 GB. This would be the case when each rank provides 4 GB of memory capacity as 8 GB and 16 GB would provide power-of-two rank numbers while 12 GB would provide three ranks or a non-power-of-two rank number in the memory system or processor memory. The restriction for a power-of-two number of ranks in processor or main memory has resulted in many computers or computer devices including more memory than required for particular uses or applications.

### SUMMARY OF THE INVENTION

Briefly, memory controllers or memory control units (MCUs) are described that include a physical address (PA) to DRAM address (DA) converter. The PA-to-DA converter is adapted to support processor memory or computer memory systems that include ranks having a number that is not a power of two (i.e., have a number of ranks that are not equal to 2̂N, where N is a positive integer). For example, the main memory or processor memory may include one or more memory modules (such as DIMMs or the like) with a non-power-of-two number of ranks such as 3, 5, 6, 7, and so on. The PA-to-DA converter is configured in some cases to provide low rank addressing of the processor memory that includes identifying a set of rank select bits in a PA in a read or other memory access request (e.g., two or more lower order bits of the PA used to identify the rank to be accessed). The PA-to-DA converter functions to determine whether the rank select bits map to an absent rank (such as map to Rank 3 when the memory only has Ranks 0, 1, and 2 or the like). If not, PA to DA conversion may continue, but when an absent rank is identified or mapped by the rank select bits, the converter functions to swap the lower order rank select bits with higher order bits (such as the highest bits of like number). Then, PA to DA conversion or operations may continue with this modified or converted address, which now maps to a rank present in the processor memory (e.g., a PA that previously had mapped to Rank 3 when only Ranks 0, 1; and 2 were present in memory may be converted to map to Rank 0 (or to Rank 1 or 2), but to an address in Rank 0 (or Rank 1 or 2) that would otherwise go unaccessed).

More particularly, a computer or electronic device is provided that is adapted for low rank addressing of processor or main memory. The memory system comprises memory modules arranged in or having ranks of a number equal to a non-power-of-two (i.e., number of ranks does not equal 2̂N, where N is a positive integer). The computer includes a processor receiving memory access requests (such as read requests) that each include a physical address to the memory system. The computer further includes a memory controller or MCU that is communicatively linked to the processor and the memory system. The MCU includes a PA-to-DA converter that maps the PA of the each of the memory access requests to an address associated with one of the ranks present in the memory modules. The mapping performed by the converter may simply involve identifying the rank select bits and determining that these map to a rank present in the memory modules. But, the mapping may also include determining that the rank select bits map to a rank that is absent from the memory modules, and then mapping the PA to a PA that is associated with one of the ranks present in the memory modules (e.g., to a PA that otherwise would not be accessed by software or the like issuing the access request but that map to a proper rank).

Typically, the rank select bits include a set or number of the lower order bits of the PA (such as the lowest 2 to 3 or more of the PA bits as may be needed to identify all of the ranks in the memory system). The mapping of the received PA to a PA associated with a present one of the ranks may include swapping or switching the rank select bits with a set of higher order bits of the received PA, such that the PA is converted into an address with rank select bits that map to a present rank. PA to DA operations may then be continued by the memory controller to generate a DA from the received (and now converted) PA. The higher order bits typically include a contiguous number or set of bits in the PA beginning with the highest order bit of the PA and having a number equal to the number of bits in the rank select bits (e.g., if the lowest 2 bits are used to select a rank, the highest 2 bits may be swapped in the PA to create an address that can then be converted into a DA with proper mapping to a rank present in the memory modules). In some cases, the number of bits in the rank select bits is only 2 (e.g., only 3 ranks are present in memory) while in other cases the number of bits is 3 or more (e.g., when there are more than 4 ranks present).

According to another aspect or embodiment, a processor is provided that is adapted for low rank addressing of processor memory, which may have a number of ranks that is equal to a non-power-of-two (such as 3, 5, or the like). The processor includes one or more cores that receive memory access requests (due to a load or store instruction from software) to the processor memory (e.g., one or more DIMMs or the like), and the requests each including a physical address. The processor also includes a memory controller connected to the core(s). The memory controller functions to generate an address to the processor memory (e.g., a DA that may be asserted via a bus using a chip select or the like). The generating of the address includes identifying select rank bits in the physical address, determining whether the select rank bits map to a rank that is absent (or not present) in the ranks of the processor memory, and when the physical address maps to an absent rank, modifying the physical address to include a modified set of select rank bits that are mapped to one of the ranks present in the processor memory (e.g., an original set of select rank bits may map to Rank 3 when only Ranks 0, 1, and 2 are present in processor memory and the modification may change the select rank bits to 0, 1, or 2). The modifying of the physical address may include swapping the rank bits with a differing set of bits in the physical address such as switching the lower or lowest two bits (or some other predetermined number useful for defining all of the ranks in the processor memory) with the higher or highest two bits (or other number). The memory controller may then carry on with PA to DA conversions with the modified physical address (which is mapped to a present one of the ranks in the processor memory).

### BRIEF DESCRIPTION OF THE DRAWINGS

FIG. 1 illustrates in functional block form a computer or computer system including a memory controller with a PA-to-DA converter (e.g., conversion logic implemented in hardware of a chip) for supporting processor memory with a non-power-of-two number of ranks;

FIG. 2 illustrates a table of addresses involved in a low rank system with only three ranks (i.e., a non-power-of-two number of ranks in processor memory) showing problems with conventional low rank addressing with such memory system and mapping of PA to DA by converter or conversion logic such as the converter of the memory controller of FIG. 1;

FIG. 3 is a functional block illustration of a computer or computer systems with a processor including PA-to-DA conversion logic in a memory control unit (MCU); and

FIG. 4 illustrates a portion of PA to DA operation, performed at least in part by a MCU, for a memory system supporting use of ranks having a number that is not a power of two.

### DETAILED DESCRIPTION OF THE PREFERRED EMBODIMENTS

The following description describes use of a physical address (PA) to DRAM address (DA) conversion procedure to facilitate use of processor memory systems that have a number of ranks that may be either a power of two or a non-power of two (i.e., the number of ranks in the DIMM modules are not required to be equal to 2̂N, where N is a positive integer, as is the case with conventional processors). The PA-to-DA conversion procedure (or mapping or addressing) may be performed as part of low rank addressing operation(s) carried out by a memory controller or memory control unit (MCU), which is used by or included in a processor. For example, the PA-to-DA conversion procedure described herein may be implemented in hardware provided within the MCU, and the MCU functions to implement low rank addressing that uses a portion of the lower order PA bits to select a rank for the DA. Briefly, when a non-power-of-two number of ranks are present in the processor memory or memory system, the PA-to-DA conversion logic of the MCU swaps a like number of highest order bits with such lower order PA bits when a PA address points to an absent rank so as to map the PA address to a present or available rank. This results in more effective use of all available memory (e.g., addresses that otherwise gone unused or unaccessed by software will now be used) while allowing memory capacity to be better matched to needs of a customer or computer designer as computers can be provided with nearly any number of ranks in the DIMM or other memory modules. Also, this swapping procedure to remap a physical address results in combinational logic using only fewer logic gates and thus enabling the PA-to-DA conversion procedure done really fast. Without this procedure, the PA to DA conversion may have had to be accomplished, for example, using more logic intensive and/or software-based techniques such as a MOD(N) operation, where N is the number of non-power-of-two ranks, but this would be much more logic intensive.

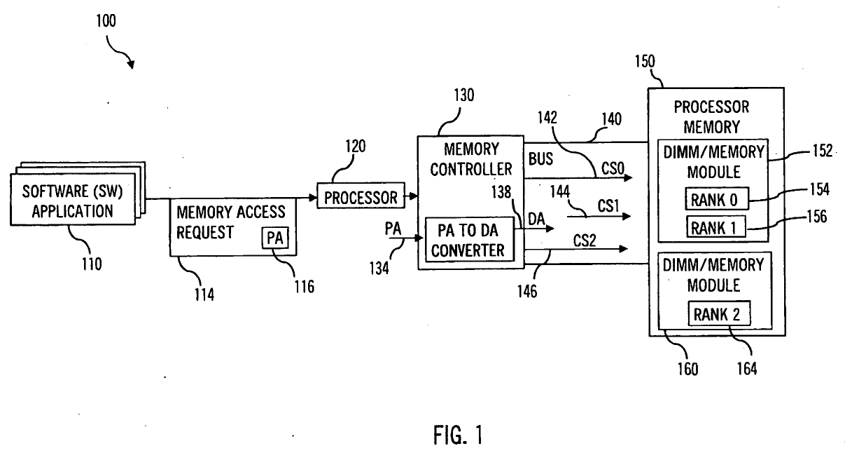

FIG. 1 illustrates a computer or computer system 100 with a memory controller 130 with an embodiment of a PA-to-DA converter 132 useful for converting a PA 134 to a DA 138 according to the conversion techniques described herein. The computer 100 may be any of a large number of computers with a processor 120 that uses a memory controller 130 to manage data accesses (e.g., read, writes, loads, stores, and the like) of processor or main memory 150. The computer 100 may be a server, personal computer, workstation, laptop, or similar device with a CPU or microprocessor 120 that is provided with an MCU 130 in its die or the processor 120 and memory controller 130 may be provided on separate chips of a board with one or more busses 140 providing access to processor memory 150. In one embodiment, for example, the processor 120 is a processor available from Sun Microsystems, Inc. such as a KT processor in which the processor 120 and MCU 130 are provided in a single chip (or the MCU is provided in the CPU die).

As shown, software (SW) or applications 110 are run by the processor 120 and present memory access requests 114 to the processor 120, and the memory access requests (such as a read request or the like) 114 include or indicate a PA 116. The processor 120 uses the memory controller 130 to generate a DA 138 to enable accessing of the processor memory 150 with chip selects 142, 144, 146. The processor memory 150 is shown to include memory modules 152, 160 (e.g., one or more DIMM or the like), and, significantly, the memory modules 152, 160 are allowed to have or be arranged to have a number of ranks that are not equal to 2̂N, with N being a positive integer (i.e., a rank number that is a non-power-of-two). As shown, the processor memory 150 includes three ranks (not 2, 4, 8, and so on) 154, 156, 164 that are numbered 0, 1, and 2, and the memory controller 130 uses like numbered chip selects (CSs) 142, 144, 146 to access these ranks of processor memory 150. As explained below, the PA-to-DA converter 132 provides the logic to facilitate conversion of a PA to a DA as part of a low rank addressing operation by mapping PA 134 that attempt to access absent ranks to available ones of the ranks 154, 156, 164 (e.g., by swapping lowest order rank select bits of the PA 134 with highest order bits of the PA 134 to provide a proper rank select for use in DA 138).

A number of processors use lower order bit of the PA to select a rank among many ranks (e.g., the SPARC processors available from Sun Microsystems, Inc. including the KT processor have low rank memory systems). The use of lower order address bits distributes the read and write accesses (e.g., memory access requests 114 of FIG. 1) uniformly across all the available ranks and yields good performance. The PA-to-DA converter 132 and low rank addressing taught herein allow low rank addressing to be applied to processor memory (such as memory 150) even when rank number is not equal to a power-of-two. The method provided by the converter 132 (and elsewhere described herein) uses less than five levels of combinational logic to accommodate non-power-of-two ranks in a low rank addressing scheme (such as for use by the KT and other processors).

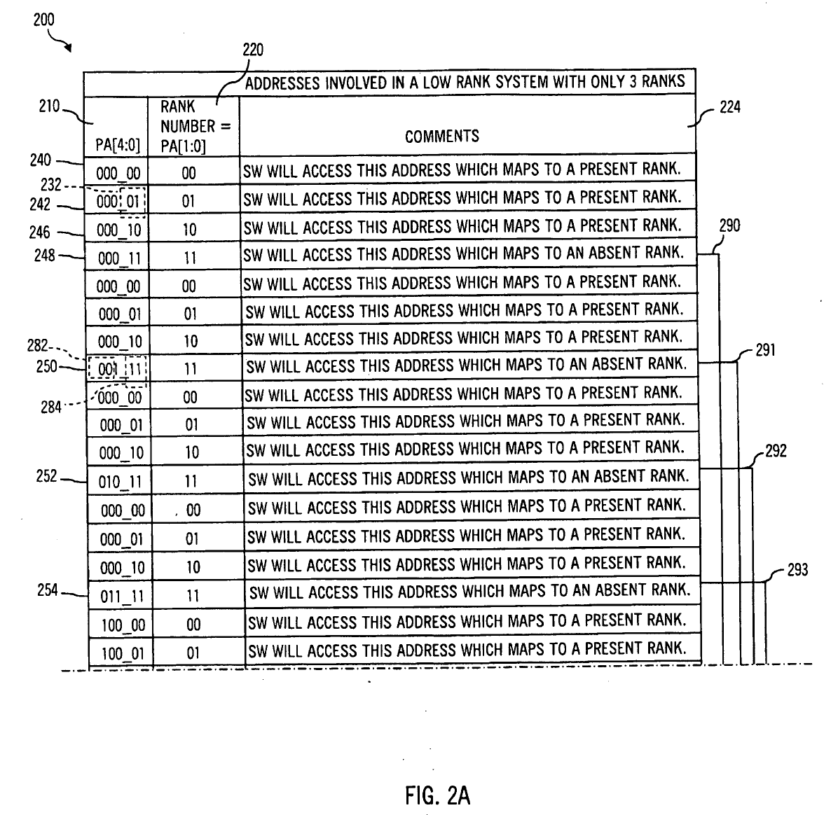

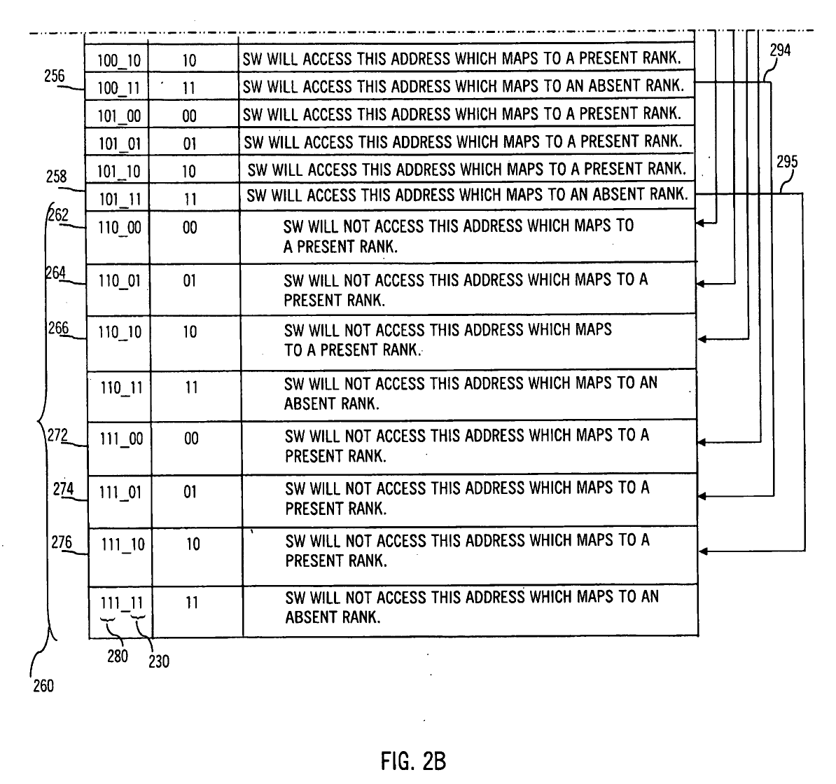

At this point, it may be useful to more fully explain one of the issues or problems with using a low rank scheme with a processor memory having non 2̂N ranks. In one example, PA[8:7] may be used to access ranks in a memory system with only three ranks. Chip selects may be asserted when PA[8:7] is either 0, 1, or 2 (as may be the case in the system 100 of FIG. 1). When software/applications (such as SW 110) accesses the fourth cache line (e.g., a cache line in this example may be 64 B) starting from address 0, PA[8:7] will be 3 for which no chip select will be asserted (e.g., CSs 142, 144, 146 in system 100 are only asserted for PA[8:7] of 0, 1, and 2). This address, which is a valid address for software (e.g., SW 110 of FIG. 1), is not mapped by any rank (such as ranks 154, 156, 164 numbered 0, 1, and 2 in processor memory 150). In embodiments taught herein, the PA-to-DA converter 132 is configured to provide a solution to address this problem, and the low rank addressing scheme is described below with reference to FIGS. 2-4.

FIGS. 2A and 2B illustrate a table of addresses involved in a low rank system with only three ranks (i.e., a memory system with a non-power-of-two number of ranks such as shown in FIG. 1). FIGS. 2A and 2B are useful for explaining the operation of embodiments of MCUs that include hardware/logic to map PA addresses to absent ranks to available or present ranks in the processor memory. In this example, with reference first to FIG. 2A, the physical addresses are shown in column 210 as they may be received or presented in a read request from software or in another memory access request and column 220 shows the rank number, which is obtained from the lowest two bits 230 (FIG. 2B) of the PA of column 210. The lowest two bits (or lower order bits) of the PA may be considered the rank select bits of the PA. Table 200 also includes a column 224 providing comments indicating whether, without further mapping or conversion by the PA-to-DA conversion logic, the software will be able to access a rank in the processor memory.

In the simplified example of table 200, PA addresses are shown in column 210 that software will access in a memory system that has three ranks and each rank is limited, for ease of explanation, to eight addresses (rather than 32 addresses per ranks as may be more typical). The lowest address that software will access is shown at row 240 as 0 and the highest address shown in table 200 as 23 in column 210 in row 258 (FIG. 2B). The addresses shown in FIG. 2 B at 260 of table 200 (e.g., PA of 24 or more) are addresses that software typically would not access without the mapping provided by memory control units described herein. In operation of the MCU and its PA-to-DA conversion logic, the three ranks are selected by three chip selects that get asserted when PA[1:0] or the select bits of the PA are equal to 0, 1, and 2. If PA[1:0] is equal to 3, the address is not mapped to any valid chip select.

For example, it can be seen for the PA of row 240, PA[1:0] is 0 such that the software access the rank having a like number (rank number of 0). In row 242, the rank select bits 232 are equal to 1, and software is able to access a present rank (rank number of 1). Also, in row 246, the PA provides PA[1:0] of 2 (in binary form) such that software is able to access the address that maps to a present rank (rank number of 2). In contrast, though, the PA of row 248 has select bits that are equal to 3, and software attempts to access an address that maps to an absent rank (e.g., without further conversion including mapping to a present rank no chip select can be asserted to convert the PA to a DA in processor memory as PA[1:0]=3 does not may to any valid chip select).

It can be observed in table 200 that the addresses shown in column 210 (i.e., the PA addresses seen by the software) that the software accesses are contiguous from 0 to 23. Of these twenty-four addresses, with reference to FIGS. 2A and 2B, all are mapped by ranks present in the memory system except those of rows 248, 250, 252, 254, 256, 258. In the portion 260 of the table 200 shown in FIG. 2B, the physical addresses do not get accessed by software via the processor and one or more MCUs. However, the physical addresses in rows 262, 264, 266, 272, 274, 276 provide addresses with rank select bits matching available or present ranks in the memory system (e.g., software, without further mapping/conversion, will not access these addresses even though they map to a present rank).

In some embodiments, the PA-to-DA converter or conversion logic of the MCU is adapted to map each of the physical addresses for which software accesses an address that does not map to a present rank to a physical address that software otherwise would not access but that maps to a rank present in the memory system or processor memory. As shown with the example of the table 200 with reference to FIGS. 2A and 2B, the PA of row 248 maps to an absent rank, and the PA-to-DA converter acts to map it to the PA of row 262 as shown with arrow 290, which maps to a present rank (but would otherwise go unaccessed by software). Likewise, the PA of row 250 is mapped as shown by arrow 291 to the PA of row 264, the PA of row 252 is mapped as shown by arrow 292 to the PA of row 266, the PA of row 254 is mapped as shown by arrow 293 to the PA of row 272, the PA of row 256 is mapped as shown by arrow 294 to the PA of row 274, and the PA of row 258 is mapped as shown by arrow 295 to the PA of row 276. PA-to-DA conversion operations may then be continued after such mapping to provide the software access to the non-power-of-two ranks of the memory modules of the processor memory.

The PA-to-DA converter acts to identify the addresses associated with the rows 248, 250, 252, 254, 256, 258 by determining the lower order bits or rank select bits 230 point to an absent rank (e.g., PA[1:0]=3 in this non-limiting example). Then, the converter functions to convert the PA to a PA with rank select bits mapping to a present rank by swapping the lower order bits or rank select bits with a like number or the highest order bits (e.g., the highest two bits in table 200) 280. For example with reference to row 250, the PA provides an address with a rank number of three, and software will access this address but it maps to an absent rank. The PA-to-DA converter makes this determination and then swaps the lower order or rank select bits 284 with the highest order bits of equal number (two in this case) 282. In this case, this results in a mapping as shown at 291 to the PA of row 262 (e.g., received PA is converted from PA[4:0]=001_{—}11 to PA[4:0]=111_{—}00), which software can access and which maps to a present rank (i.e., rank number=0). In other words, the PA is re-mapped to point to Rank 0 rather than Rank 3 such that the PA will have a chip select and be able to access a module of processor memory.

In this example, the method of remapping the PAs found in rows 248, 250, 252, 254, 256, and 258 may be implemented by comparing PA[1:0] against 2′b11 and swapping it with PA[4:3]. A more generic way of stating this swapping or mapping method implemented by the MCU or memory controller is to swap the minimum number of lower order PA bits used to represent the total number of ranks in the memory system with that same number of higher order bits. The PA-to-DA conversion logic described may readily be implemented within a memory controller or MCU used by or a part of the processor using simple combinational logic provided by a relatively small amount of hardware components (e.g., with a set of comparators and muxes or the like).

In another practical example, a memory system may have a total number of ranks of 12 (again, a non-power-of-two number of ranks). The minimum number of lower order PA bits (or rank select bits) are PA[10:7] in a memory system where the cache line size is 64 B. If PA[10:7] matches an absent rank, then the PA-to-DA converter of the MCU may act to swap PA[10:7] or the rank select bits with PA[N,3] or the highest order bits of like number as the rank select bits (where N is the highest address bit). This method enables computing a DRAM address from the received PA without increasing the delay and can be implemented in nearly any processor (such as a KT SPARC processor or the like) using a low rank memory system with a number of ranks that are not equal to 2̂N, with N equal to a positive integer.

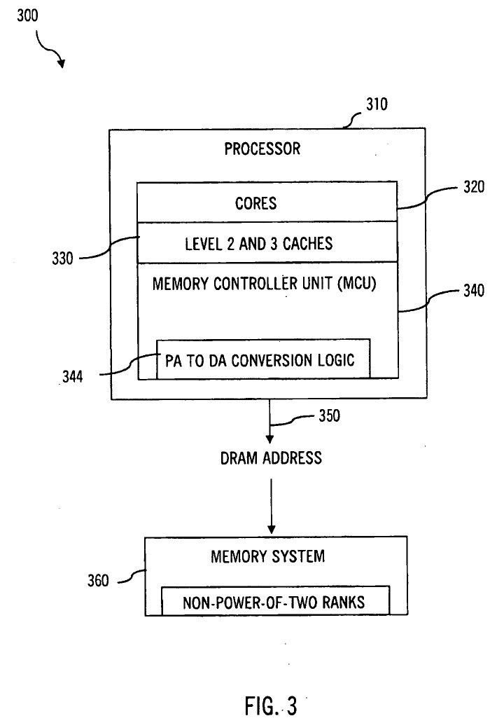

FIG. 3 illustrates an exemplary computer or electronic device 300 that may implement the PA to DA conversion techniques described herein. The computer 300 includes a processor 310 with one or more cores 320 and caches 330. The processor 310 further includes a MCU 340 (e.g., on the processor chip or the like) that includes hardware to provide PA-to-DA conversion logic 344, and the logic 344 functions to convert a received PA into a DA even when the number of ranks present in a processor memory is not equal to 2̂N, with N being a positive integer. As shown, the PA-to-DA conversion logic 344 outputs a DRAM address 350 to/for a memory system 360 that is configured with non-2̂N ranks (e.g., 3, 5, 6, 7, 9, 10, 11, 12, or so on number of ranks).

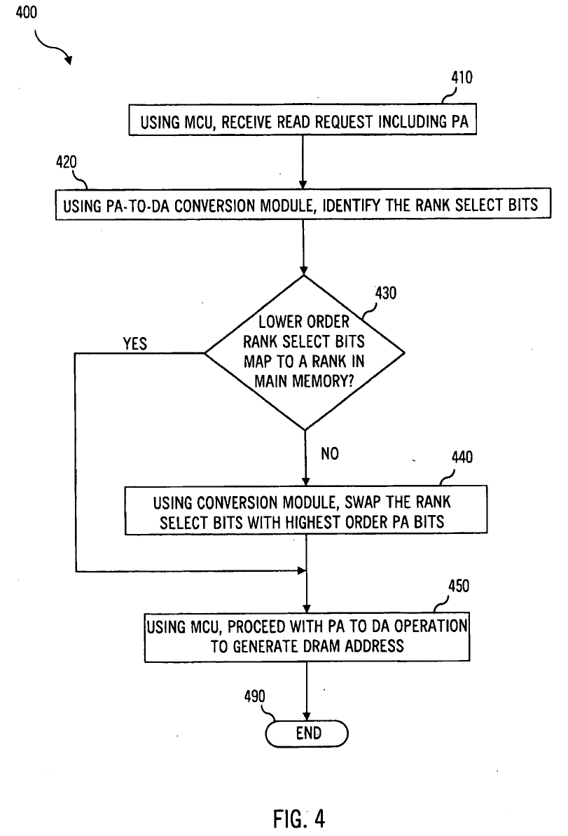

FIG. 4 illustrates a PA to DA conversion process 400 that may be implemented by a described embodiment of a memory controller with a PA-to-DA converter (or conversion logic). The process 400 begins at 410 with a MCU receiving a read request (or other memory access request) that includes a PA. The request may be from software or applications run by or accessing the processor(s) associated with the MCU. At 420, the process 400 continues with the MCU (or its PA-to-DA conversion module) identifying the rank select bits (i.e., the lower order bits of the PA used to identify each of the ranks present in the DIMM or other processor memory modules). At 430, the MCU (or its conversion module) acts to determine whether the lower order rank select bits (identified in step 420) map to a rank that is present in main or processor memory. If so, the process 400 continues at 450 with PA-to-DA conversion operations to generate a DRAM address that maps to a present rank (and can be performed by asserting a chip select). If not, at 440, the method 400 continues with swapping the identified lower order rank select bits with the highest order PA bits (of like number) using the MCU (or its conversion module/hardware). After the bit swapping is complete, the method 400 may carry forward with the remainder of the PA-to-DA operation to produce a DRAM address that software accesses and that maps to a present rank (e.g., can be asserted with a chip select). The method 400 ends at 490 (with the MCU awaiting a next memory access request with a PA to process or convert into a DA).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

I claim:

1. A computer adapted for low rank addressing of main memory, comprising:
a memory system comprising memory modules arranged in ranks, where the ranks have a number equal to a non-power-of-two;
a processor receiving memory access requests each including a physical address (PA) to the memory system; and
a memory controller communicatively linked to the processor and the memory system, wherein the memory controller comprises a PA-to-dynamic random access memory (DRAM) address (PA-to-DA) converter mapping the PA of each of the memory access requests to an address associated with one of the ranks of the memory modules.

2. The computer of claim 1, wherein for each of the memory access requests the mapped PA comprises rank select bits of the PA and when the identified rank select bits map to an absent rank from the memory modules, the mapped PA is mapped to another PA associated with a present rank in the memory modules.

3. The computer of claim 2, wherein the rank select bits comprise a set of lower order bits of the PA.

4. The computer of claim 3, wherein the mapping of the PA to another PA comprises swapping the rank select bits of the PA with a set of higher order bits of the PA, whereby the PA is converted to an address with rank select bits mapping to one of the ranks present in the memory modules.

5. The computer of claim 4, wherein the set of higher order bits comprise a contiguous set of bits beginning with a highest bit of the PA and having a number equal to a number of bits in the rank select bits of the PA.

6. The computer of claim 5, wherein the number of bits is two and the number of ranks is three.

7. The computer of claim 5, wherein the number of bits is greater than two and the number of ranks is greater than four.

8. The computer of claim 1, wherein the PA-to-DA converter operates, after the mapping of the PA to the address associated with one of the ranks, to generate a DA based upon the address associated with the one of the ranks and wherein the memory controller asserts a chip select to the one of the ranks.

9. A processor adapted for low rank addressing processor memory, comprising:
a core that receives an access request to the processor memory, wherein the access request includes a physical address with a set of select rank bits and wherein the processor memory includes a number of ranks; and
a memory controller coupled to the core, wherein the memory controller generates an address to the processor memory from the physical address, the generated address includes a modified set of select rank bits mapped to a present one of the ranks in the processor memory when the select rank bits of the physical address map to an absent rank of the processor memory.

10. The processor of claim 9, wherein the number of ranks is equal to a non-power-of-two.

11. The processor of claim 9, wherein the modifying of the physical address comprises swapping the select rank bits with a differing set of bits of the physical address to provide the modified set of select rank bits.

12. The processor of claim 12, wherein the differing set of bits has a number of bits equal to the number of bits in the identified select rank bits.

13. The processor of claim 12, wherein the identified select rank bits are the lowest bits of the physical address and the differing set of bits are the highest bits of the physical address.

14. The processor of claim 9, wherein the number of ranks is at least about 12 and is equal to a non-power-of-two and the modified select rank bits consist of a like number of the highest order bits of the physical address.

15. A low rank addressing method for use in a memory controller associated with a processor, comprising:
identifying select rank bits of a first physical address with physical address (PA) to DRAM address (DA) conversion logic;
determining, with the PA to DA conversion logic, when the select rank bits map to a rank absent from a memory system associated with the processor;
swapping, with the PA to DA conversion logic, the select rank bits with higher order bits of the first physical address to generate a second physical address from the first physical address; and
converting the second physical address into a DA for assertion with a chip select to the memory system.

16. The method of claim 16, wherein the memory system comprises a plurality of memory modules including a number of ranks equal to a non-power-of-two positive integer.

17. The method of claim 16, wherein the select rank bits comprise a first number of the lowest order bits and the higher order bits comprise a second number of the highest order bits of the first physical address, the first and second numbers being equal.

18. The method of claim 16, further comprising receiving the first physical address with the processor in a memory access request from a software application.

19. The method of claim 15, wherein the memory system comprises memory modules with a number of ranks of at least 12 that is a non-power-of-two.

20. The method of claim 19, wherein the select rank bits include at least 3 lower order bits and the higher order bits comprise a like number of the highest order bits of the first physical address.
